(19) United States
(12) Patent Application Publication
(10) Pub. No.: US 2006/0292327 A1
(43) Pub. Date: Dec. 28, 2006

(54) Method for evaluating dye component suitability for optical recording media, optical recording material and optical recording medium

(75) Inventors: Atsushi Monden, Tokyo (JP); Masahiro Shinkai, Tokyo (JP); Junji Tanabe, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/103,475

(22) Filed: Apr. 12, 2005

(30) Foreign Application Priority Data
Apr. 21, 2004 (JP) P2004-126042

(51) Int. Cl. B32B 3/02

(52) U.S. Cl. 428/64.4

(57) ABSTRACT

The method of evaluating dye component suitability for optical recording media according to the invention comprises a first step in which the temperature of a sample containing the dye component or the temperature of the atmosphere surrounding the sample is set to two or more different prescribed temperatures, and the absorbance of the sample for light of a prescribed wavelength is measured at each of the prescribed temperatures, and a second step in which the suitability of including the dye component in the recording layer of an optical recording medium is evaluated based on one or more conditions which are set based on correlation between the prescribed temperatures and the absorbance.

### BACKGROUND OF THE INVENTION

1. Field of the Invention

The present invention relates to an optical recording medium for recording of information by irradiation of light, to an optical recording material used in the medium, and to a method for evaluating the suitability of the dye component contained therein for optical recording media.

2. Related Background of the Invention

Conventional optical recording media record information by irradiation of light such as laser light on a recording layer to produce deformational changes, magnetic changes or phase changes in the recording layer. Such optical recording media include, for example, write-once optical recording media comprising recording layers which contain organic dyes such as azo compounds, and are widely used as CD-R (CD-Recordable) and DVD±R (DVD Recordable) media.

Of the write-once optical recording media mentioned above, CD-R media are usually formed by laminating a recording layer containing a dye as the major constituent component, a reflective layer composed mainly of metal and a protective layer composed of an ultraviolet curing resin or the like in that order on a round base with a guide groove. DVD±R media are formed by laminating the same layers as a CD-R, and adding an adhesive layer and a base on the protective layer.

The principle for recording and reading of information may be explained more specifically as follows. First, when laser or another form of light is irradiated onto the recording layer of the optical recording medium while moving it relative to the optical recording medium at a prescribed speed in the transverse direction, the irradiated light energy is absorbed by the dye component in the recording layer, thereby heating it. This results in thermal deformation of the laser light-irradiated regions and surrounding regions of the recording layer due to decomposition, vaporization and dissolution, thereby forming pits (this will hereinafter be referred to as the “recording principle”). In the case of a CD-R or DVD-R, the aforementioned movement of laser light is accomplished by rotating the disk in such a manner that the linear speed of the laser light with respect to the disk is constant.

For reading of the information, light is irradiated onto the recording layer which has the pits formed by thermal deformation, and a difference in reflectance of the light is produced between the pit sections and non-pit sections. The difference in reflectance is read by an optical detector and converted to electrical signal variations to allow reading of the information (this will hereinafter be referred to as the “reading principle”). Thus, it is difficult to read the information with adequate precision and accuracy unless the pits are formed at the proper sections and satisfactory recording characteristics are achieved.

One of the factors affecting the recording characteristics is the type of dye material used in the recording layer. A conventional method, which has been investigated for evaluating whether or not the recording layer contains a dye material conferring satisfactory recording characteristics, has been to employ thermogravimetry (TG) and/or differential thermal analysis (DTA) for one or more the different dye materials (hereinafter referred to as “dye components”) as constituents of the recording layer (see Japanese Patent Application Laid-Open No. 08-297838, Japanese Patent Application Laid-Open No. 09-58123, Japanese Patent Application Laid-Open No. 09-274732, Japanese Patent Application Laid-Open No. 10-6644, Japanese Patent Application Laid-Open No. 10-188341 and Japanese Patent Application Laid-Open No. 11-70732). There have also been proposed optical recording media comprising dye materials in the recording layer which satisfy prescribed evaluation criteria according to TG and/or DTA.

For example, the purpose of providing an optical recording medium suitable for recording at shorts wavelengths of 600-700 nm may be achieved in the manner described in Japanese Patent Application Laid-Open No. 9-58123, which discloses an optical recording medium wherein optical changes are produced in the recording layer by laser light with a wavelength of 600-700 nm, and wherein thermogravimetry of the organic dye shows a weight loss slope of at least 2%/° C. for the temperature during the main weight loss process (weight loss of 18% or greater), while thermogravimetry shows a total weight loss of 25% or greater during the main weight loss process.

Also, the purpose of providing an optical recording medium capable of high-density recording may be achieved in the manner described in Japanese Patent Application Laid-Open No. 10-6644 proposes an optical recording medium wherein the recording layer comprises a mixture composed of a main component dye A which satisfies the condition of exhibiting a weight loss slope of between 0.5%/° C. and 3%/° C. based on temperature increase during the main weight loss process (weight loss of 15% or greater), according to thermogravimetry, with a loss of 40-55% of the total weight during the main weight loss process, or a weight loss slope of between 3%/° C. and 20%/° C. during the main weight loss process with a loss of 30-50% of the total weight during the main weight loss process; and a compound B which satisfies the condition of exhibiting a weight loss slope of at least 10%/° C. during the main weight loss process, with a loss of at least 55% of the total weight during the main weight loss process, or a weight loss slope of less than 10%/° C. during the main weight loss process with a loss of at least 75% of the total weight during the main weight loss process.

Also, the purpose of obtaining a high-capacity optical recording medium with high reflectance, suitable for short-wavelength recording, may be achieved in the manner described in Japanese Patent Application Laid-Open No. 10-188341, which discloses an optical recording medium wherein one of the following conditions is satisfied: the recording layer comprises an organic dye which, according to thermogravimetry, undergoes substantially no loss at temperatures lower than the initial temperature of the main loss and has a loss slope of at least 2%/° C. during the main loss process, with a total loss of 30% or greater, wherein based on differential thermal analysis the thermal peak size is between −10 μV/mg and 10 μV/mg and the peak width is no greater than 20° C., or on a recording layer comprising an organic dye wherein, based on differential thermal analysis, the thermal peak size is between 10 μV/mg and 30 μV/mg and the peak width is no greater than 20° C., there is formed a metal reflective layer wherein the reciprocal of the specific electrical resistance value near room temperature is between 0.20/μΩcm and 0.30/μΩcm, the refractive index with reproduction light of ±5 nm is between 0.1 and 0.2 and the extinction coefficient is between 3 and 5.

### SUMMARY OF THE INVENTION

In recent years there has been a need for higher bit densities in recording layers to allow recording of greater volumes of data on optical recording media, as well as a demand for higher speeds in linear recording (recording speeds) of information in order to shorten recording times.

However, based on detailed research by the present inventors with regard to conventional optical recording media including those described in the aforementioned patent documents, it was found that it is difficult to ensure sufficient recording characteristics particularly during high-speed recording even when such dye components satisfying the conventional evaluation criteria are used in optical recording media. That is, it was found that when dye components satisfying the evaluation criteria described in the aforementioned patent documents are used as constituent materials of recording layers in order to achieve higher recording speeds, it becomes difficult to obtain the desired pit lengths, resulting in a tendency toward increased jitter and a higher error rate. This tendency becomes particularly notable when attempting to produce recording patterns with relatively short distances between pits, and it has been demonstrated to be especially prominent when such recording patterns are continuous, i.e. when performing high-density recording. Although the reason for this has not been fully elucidated, the present inventors believe part of the reason to be the following. However, the concept is not limited to the one explained here.

The recording layer dye components disclosed in the aforementioned patent documents of the prior art, which generally exhibit rapid weight reduction with increasing temperature according to TG, are considered satisfactory for producing optical recording media with excellent recording characteristics. Dye components exhibiting such thermal behavior exhibit their weight reduction only at relatively high temperatures, and therefore irradiation with high energy laser is necessary to form the pits. When the recording speed is a low speed such as 2×, i.e. a linear speed of 7 m/sec, problems do not usually arise in the recording characteristics even when high energy lasers are used for irradiation.

However, the present inventors believe that when high energy laser light is irradiated in sections with recording patterns wherein the distances between recording pits are short, the laser-generated heat is readily transferred to adjacent pits with increasing recording speed, tending to produce frequent heat interference between the pits. With high-speed recording of information at 4× speed or higher, i.e. a linear speed of 14 m/sec or greater, the heat interference between pits presumably results in increased jitter and a higher error rate.

The present invention has been accomplished in light of these circumstances, and its object is to provide an optical recording medium with sufficiently superior recording characteristics particularly for high-speed recording, as well as an optical recording material to be used in such an optical recording medium, and a method for evaluating the suitability of dye components for obtaining optical recording media or optical recording materials.

As a result of much diligent research directed toward achieving the aforestated object, the present inventors discovered that the results obtained by analysis of a dye component by a method of analysis and measurement different from conventional TG-DTA are in a correlation with the suitability of the dye component when used in the recording layer of an optical recording medium (for example, the property of adequately suppressing jitter and error rate for recording of information; referred to as “suitability for optical recording media” throughout the present specification), and the present invention was completed upon this discovery.

Specifically, the method of evaluating dye component suitability for optical recording media according to the invention (hereinafter referred to simply as “suitability evaluating method”) comprises a first step in which the temperature of the sample containing the dye component or the temperature of the atmosphere surrounding the sample is set to two or more different prescribed temperatures, and the absorbance of the sample for light of a prescribed wavelength is measured at each prescribed temperature, and a second step in which the suitability of including the dye component in the recording layer of an optical recording medium is evaluated based on one or more conditions which are set based on correlation between a prescribed temperature and absorbance.

Here, the “absorbance” refers to the degree of light absorption by the substance (according to the invention, the sample containing the dye component), and generally it may be expressed as −log(Io/Ii) where Ii is the intensity of light incident to the substance and Io is the intensity of light transmission (and reflection) from the substance.

According to the suitability evaluating method of the invention, thermal deformation of the dye component by decomposition, vaporization and dissolution with heat treatment results in a change in its absorbance, and therefore measuring the absorbance of the sample containing the dye component will indirectly allow information to be obtained relating to thermal deformation of the dye component. On the other hand, when laser light is irradiated onto the optical recording medium during recording and reading, a temperature change occurs in the irradiated area of the recording layer of the medium and its surrounding areas. Thus, obtaining the aforementioned information relating to thermal deformation allows evaluation of the suitability of the dye component for optical recording media.

The prescribed wavelength for the suitability evaluating method of the invention is preferably smaller than the wavelength of the laser light irradiated onto the optical recording medium during recording and/or reading of the optical recording medium. The absorbance of the dye component at that wavelength will tend to correlate more closely with the suitability of the dye component for optical recording media. Particularly if the laser light has a wavelength of 650 nm as for DVD, the prescribed wavelength is preferably in the range of 500-650 nm.

This condition for the suitability evaluating method of the invention is preferably represented by the following inequalities (1) and (2).
200≦T₁≦250 (1)
[wherein T₁ represents a prescribed temperature which produces absorbance satisfying the relationship represented by the following equality (3):
A₁=A₂₅/2 (3)
(wherein A₁ represents the absorbance at T₁ and A₂₅ represents the absorbance at 25° C.)].
0.50≦{(A₂₀₀−A₂₅₀)/A₂₀₀}≦1.00 (2)
(wherein A₂₀₀ represents the absorbance at 200° C. and A₂₅₀ represents the absorbance at 250° C.).

The optical recording material of the invention is an optical recording material used for an optical recording medium capable of recording information by irradiation of light, wherein the dye component contained in the optical recording material simultaneously satisfies the conditions represented by inequalities (1) and (2) above when the temperature of the sample containing the dye component or the temperature of the atmosphere surrounding the sample is set to two or more different prescribed temperatures, and the absorbance of the sample for light of a prescribed wavelength is measured at each prescribed temperature.

The optical recording medium of the invention is an optical recording medium capable of recording information by irradiation of light, wherein the dye component contained in the recording layer provided in the optical recording medium simultaneously satisfies the conditions represented by inequalities (1) and (2) above when the temperature of the sample containing the dye component or the temperature of the atmosphere surrounding the sample is set to two or more different prescribed temperatures, and the absorbance of the sample for light of a prescribed wavelength is measured at each prescribed temperature.

If the recording layer provided in the optical recording medium contains a dye component satisfying the conditions described above, the optical recording medium will be resistant to increased jitter and will have a reduced error rate, thus exhibiting sufficiently superior recording characteristics. In particular, the optical recording medium will exhibit notably superior recording characteristics with high-speed recording at at least 4× speed, i.e. a linear speed of 14 m/sec or greater.

According to the invention it is possible to provide an optical recording medium with sufficiently superior recording characteristics particularly for high-speed recording, and an optical recording material for use in such an optical recording medium. In addition, it is possible to provide a method for evaluating the suitability of a dye for obtaining such an optical recording medium or optical recording material.

### BRIEF DESCRIPTION OF THE DRAWINGS

FIG. 1 is a schematic absorption spectrum diagram for different prescribed temperatures according to the invention.

FIG. 2 is another schematic absorption spectrum diagram for different prescribed temperatures according to the invention.

FIG. 3 is a schematic absorption spectrum diagram for illustration of the optical recording medium suitability evaluating method according to the invention.

FIG. 4 is a graph schematically showing a plot of absorbance and prescribed temperature for illustration of the optical recording medium suitability evaluating method according to the invention.

FIG. 5 is a partial cross-sectional view showing a preferred embodiment of an optical recording medium according to the invention.

FIG. 6 is a partial cross-sectional view showing an embodiment of an optical recording medium according to the invention.

### DESCRIPTION OF THE PREFERRED EMBODIMENTS

The present invention will now be explained in greater detail using preferred embodiments of the invention, with reference to the drawings where necessary. Throughout the drawings, corresponding elements will be referred to with like reference numerals and will be explained only once. The vertical and horizontal positional relationships are based on the positional relationships shown in the drawings, unless otherwise specified. Also, the dimensional proportions of the drawings are not limited to the proportions illustrated.

An optical recording material according to a preferred embodiment of the invention will be explained first. The optical recording material of this embodiment is an optical recording material for use in an optical recording medium capable of recording information by irradiation of light, and the dye component in the optical recording material satisfies the conditions represented by inequalities (1) and (2) above when the temperature of the sample containing the dye component or the temperature of the atmosphere surrounding the sample is set to two or more different prescribed temperatures, and the absorbance of the sample for light of a prescribed wavelength is measured at each prescribed temperature. In order to include the dye component in the recording layer, a dye component consisting solely of a dye material obtained by synthesis or preparation by a publicly known method, or a known (commercially available) dye material, or else a dye component comprising a plurality of different dye materials, may be subjected to a repeated process of analysis and measurement by publicly known spectrophotometric analysis to obtain a dye component which satisfies the conditions represented by inequalities (1) and (2) above.

The types of dye materials and their proportions in the dye component are not particularly restricted so long as the dye component conforms to the aforementioned conditions. Thus, for example, a chelate compound comprising an azo compound and a metal may be used alone or two or more different chelate compounds of such type may be used in combination, while a dye material with a different chelate compound may also be added to the chelate compound.

The azo compound is not particularly restricted so long as it is a compound with a functional group represented by —N═N—, and as examples there may be mentioned compounds having an aromatic ring bonded to the two nitrogen atoms, and more specifically the compounds represented by general formula (A) below. In formula (A), Q¹ represents a divalent residue which binds to the nitrogen atom and to the carbon atom bound to the nitrogen atom to form a heterocycle or a fused ring containing a heterocycle. Q² represents a divalent residue which binds to the mutually bound carbon atoms to form a fused ring.

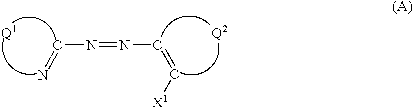

X¹ is a functional group with one or more active hydrogen atoms, and for example, there may be mentioned hydroxyl (—OH), thiol (—SH), amino (—NH₂), carboxyl (—COOH), amide (—CONH₂), sulfonamide (—SO₂NH₂), sulfo (—SO₃H) and —NSO₂CF₃.

As such azo compounds there may be mentioned the compounds represented by the following general formulas (4) to (7). 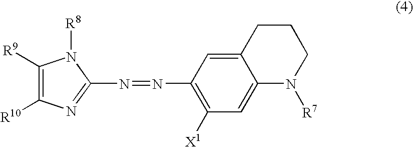
(wherein R⁷ and R⁸ may be the same or different and each independently represents C1-4 alkyl, R⁹ and R¹⁰ may be the same or different and each independently represents nitrile or a carboxylic acid ester group, and X¹ has the same definition as above. Preferred carboxylic acid ester groups are —COOCH₃, —COOC₂H₅ and —COOC₃H₇.) 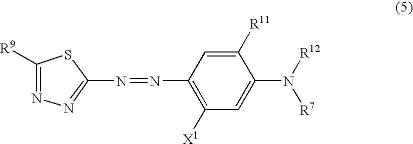
(wherein R¹¹ represents hydrogen or C1-3 alkoxy, R¹², R⁷ and R⁸ may be the same or different and each independently represents C1-4 alkyl, and X¹ has the same definition as above.) 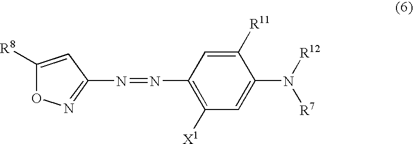
(wherein R¹¹, R¹², R⁷, R⁸ and X¹ have the same respective definitions as R¹¹, R¹², R⁷, R⁸ and X¹ in formula (5)). 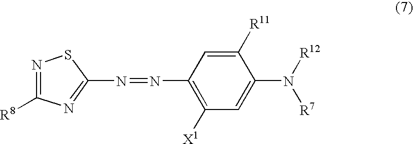
(wherein R¹¹, R¹², R⁷, R⁸ and X¹ have the same respective definitions as R¹¹, R¹², R⁷, R⁸ and X¹ in formula (5)).

As metals (central metals) of the aforementioned chelate compound there may be mentioned titanium (Ti), vanadium (V), chromium (Cr), manganese (Mn), iron (Fe), cobalt (Co), nickel (Ni), copper (Cu), zirconium (Zr), niobium (Nb), molybdenum (Mo), ruthenium (Ru), rhodium (Rh), palladium (Pd), silver (Ag), cadmium (Cd), indium (In), tin (Sn), antimony (Sb), tungsten (W), rhenium (Re), osmium (Os), iridium (Ir), platinum (Pt) and gold (Au). Alternatively, V, Mo and W may be in the form of the oxide ions, VO²⁺, VO³⁺, MoO²⁺, MoO³⁺, WO³⁺ and the like.

As examples for the chelate compound there may be mentioned the compounds represented by the following general formulas (8), (9) and (10), and the compounds represented in the following Tables 1 to 6 (Nos. A1-A49). These chelate compounds may be used alone or in combinations. In the chelate compounds represented as Nos. A1-A49, two azo compounds are coordinated with one central metal element. Where two different azo compounds or central metals are shown they are present in a molar ratio of 1:1, and where the central metal is indicated as “V═O”, the azo compound is coordinated with acetylacetone vanadium.

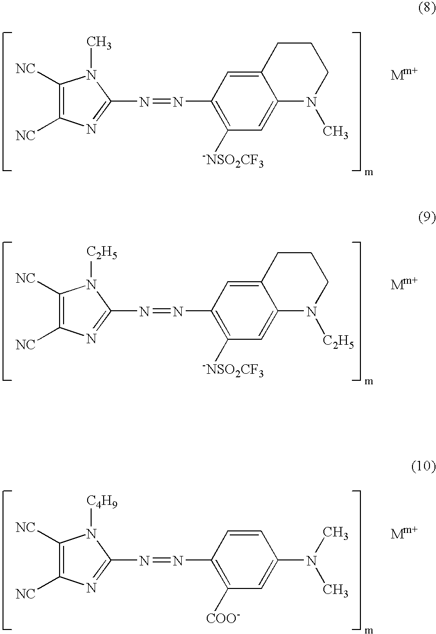

M in general formulas (8), (9) and (10) represents Ni²⁺, Co²⁺ or Cu²⁺, and m represents the valency of M.

TABLE 1

| | | Central |
|---|---|---|
| No. | Azo compound | metal |
| A1 | 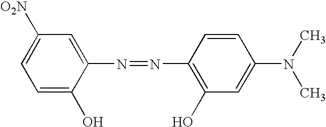 | Co |
| A2 | 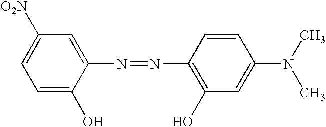 | V═O |
| A3 | 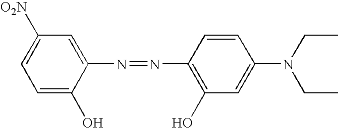 | Co |
| A4 | 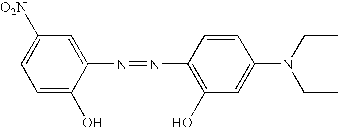 | V═O |
| A5 | 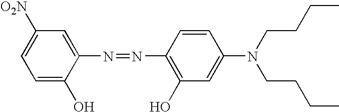 | Co |
| A6 | 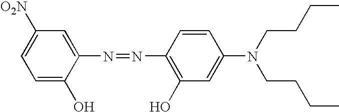 | V═O |
| A7 | 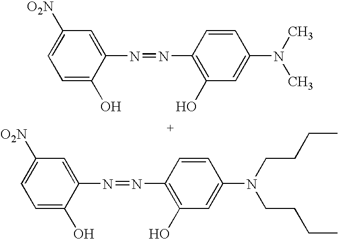 | Co |
| A8 | 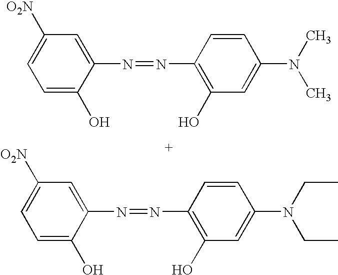 | Co |

TABLE 2

| | | Central |
|---|---|---|
| No. | Azo compound | metal |
| A9 | 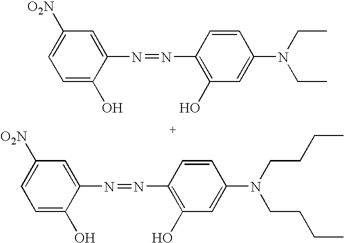 | Co |
| A10 | 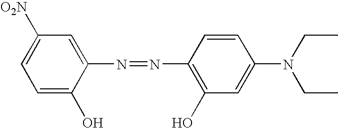 | Co +V═O |
| A11 | 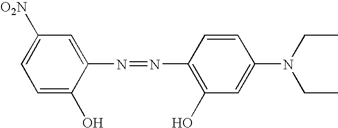 | Co +V═O |
| A12 | 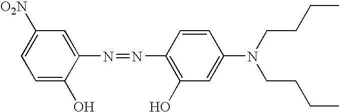 | Co +V═O |
| A13 | 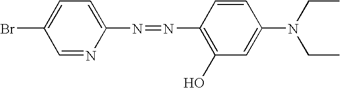 | Cu |
| A14 | 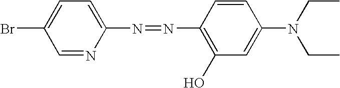 | Ni |
| A15 | 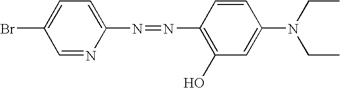 | Co |
| A16 | 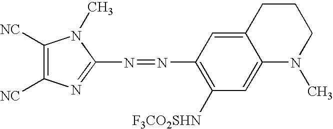 | Ni |
| A17 | 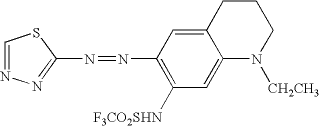 | Ni |

TABLE 3

| | | Central |
|---|---|---|
| No. | Azo compound | metal |
| A18 | 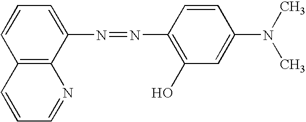 | Co |
| A19 | 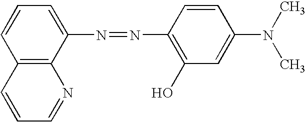 | Ni |
| A20 | 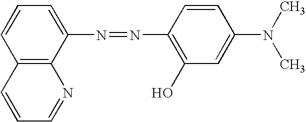 | Cu |
| A21 | 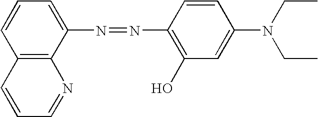 | Co |
| A22 | 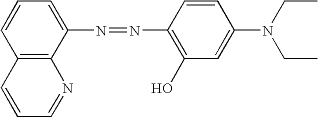 | Ni |
| A23 | 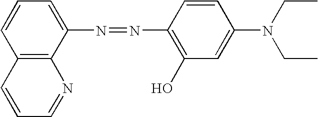 | Cu |
| A24 | 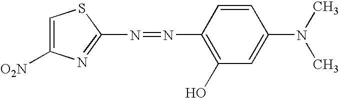 | Cu |
| A25 | 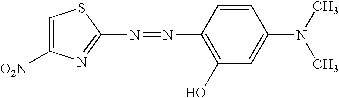 | Ni |
| A26 | 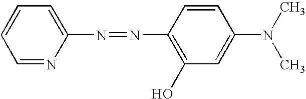 | Cu |
| A27 | 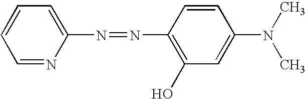 | Ni |

TABLE 4

| | | Cen- |
|---|---|---|
| | | tral |
| No. | Azo compound | metal |
| A28 | 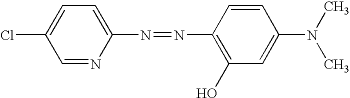 | Cu |
| A29 | 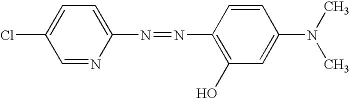 | Ni |
| A30 | 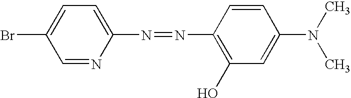 | Cu |
| A31 | 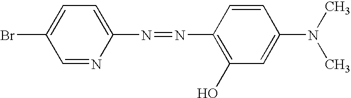 | Ni |
| A32 | 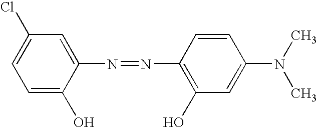 | Co |
| A33 | 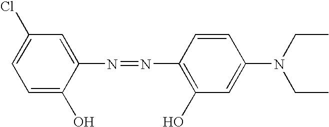 | Co |
| A34 | 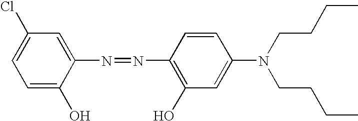 | Co |
| A35 | 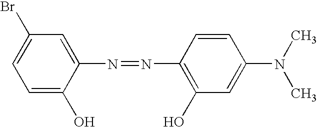 | Co |
| A36 | 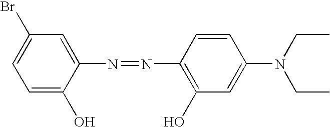 | Co |
| A37 | 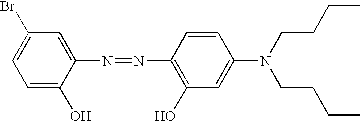 | Co |

TABLE 5

| No. | Azo compound | Central metal |
|---|---|---|
| A38 | 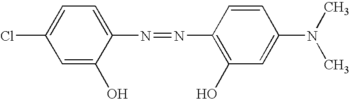 | Co |
| A39 | 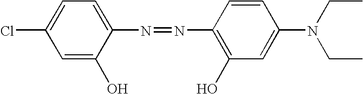 | Co |
| A40 | 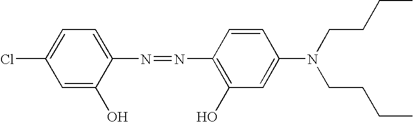 | Co |
| A41 | 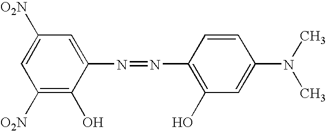 | Co |
| A42 | 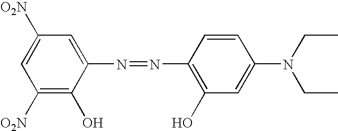 | Co |
| A43 | 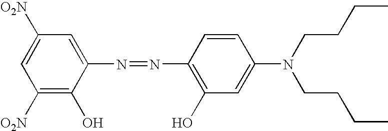 | Co |
| A44 | 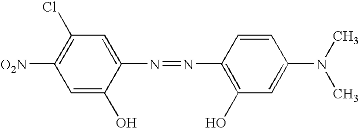 | Co |
| A45 | 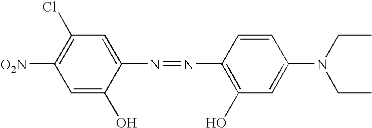 | Co |
| A46 | 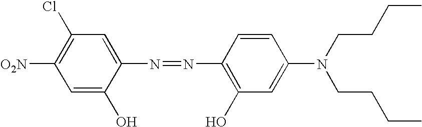 | Co |
| A47 | 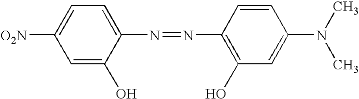 | Co |

TABLE 6

| No. | Azo compound | Central metal |
|---|---|---|
| A48 | 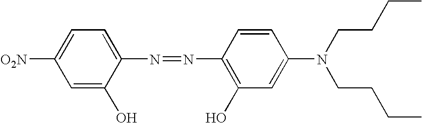 | Co |
| A49 | 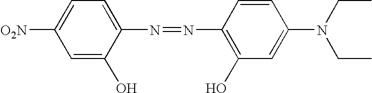 | Co |

Among these compounds there are preferred the chelate compounds represented as A13-A31. An alternative is the structure of compound A49 with the nitro and diethylamino groups removed from the molecule.

Depending on the nature of X¹, the chelate compound formed may have the active hydrogen of X¹ dissociated.

The aforementioned dye component may also contain a counter cation if the chelate compound exists as an anion, or a counter anion if the chelate compound exists as a cation. As counter cations there are preferably used alkali metal ions such as Na⁺, Li⁺ and K⁺, ammonium ion or the like. Cyanine dye described below may also be used as a counter cation for salt formation. As counter anions there are preferably used PF₆⁻, I⁻, BF₄⁻ and anions represented by the following formula (11).

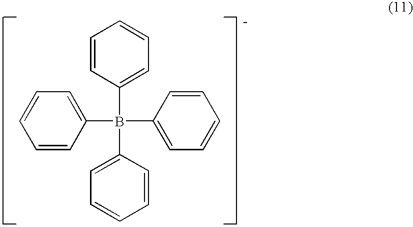

The chelate compound may be synthesized according to a publicly known process (for example, see Furukawa, Anal. Chem. Acta., 140, 289(1982)).

There are no particular restrictions on dye materials other than the aforementioned chelate compounds to be included in the dye component, and they may be publicly known materials or materials which can be synthesized by publicly known processes or according to publicly known processes; there may be mentioned cyanine dyes, squalium dyes, croconium dyes, azulenium dyes, xanthene dyes, melocyanine dyes, triarylamine dyes, anthraquinone dyes, indoaniline metal complex dyes, azomethine dyes, oxonol dyes and intramolecular CT dyes. Cyanine dyes are preferred among these, and cyanine dyes having a group represented by general formula (B) or (C) below are especially preferred. 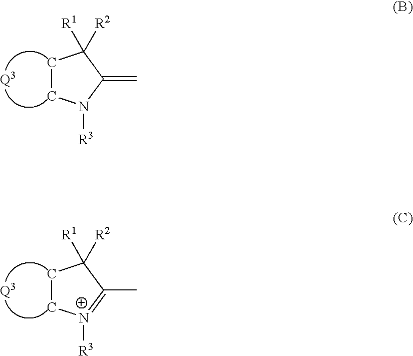
In formulas (B) and (C), Q³ represents a group of atoms forming an optionally substituted benzene ring or an optionally substituted naphthalene ring, R¹ and R² each independently represent alkyl, cycloalkyl, phenyl or optionally substituted benzyl, or are linked together to form a 3- to 6-membered ring, and R³ represents alkyl, cycloalkyl, alkoxy, phenyl or optionally substituted benzyl, the groups represented by R¹, R² and R³ being optionally substituted.

As such cyanine dyes there may be mentioned cyanine dyes represented by the following general formula (12). 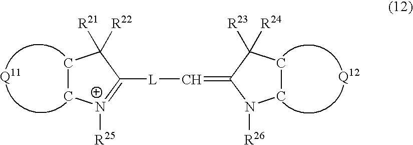
(wherein L represents a divalent linking group represented by formula (13a) below, R²¹ and R²² each independently represent C1-4 alkyl or optionally substituted benzyl, or are linked together to form a 3- to 6-membered ring, R²³ and R²⁴ each independently represent C1-4 alkyl or optionally substituted benzyl, or are linked together to form a 3- to 6-membered ring, R²⁵ and R²⁶ each independently represent C1-4 alkyl or aryl, and Q¹¹ and Q¹² each independently represent a group of atoms forming an optionally substituted benzene ring or an optionally substituted naphthalene ring, provided that at least one from among R²¹, R²², R²³ and R²⁴ represents a non-methyl group, and the divalent linking group represented by formula (13a) below may have a substituent.

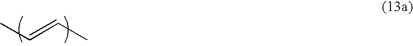

As more specific examples there may be mentioned the compounds (Nos. T1-T67) shown in Tables 7-12 below.

TABLE 7

| No. | |
|---|---|
| T1 | 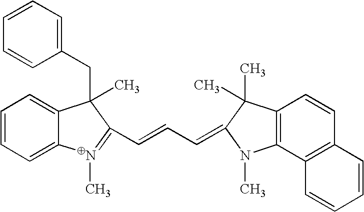 |
| T2 | 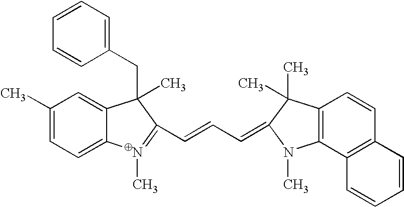 |
| T3 | 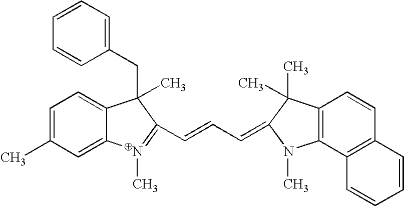 |
| T4 | 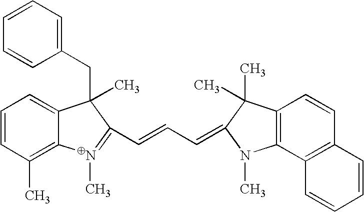 |
| T5 | 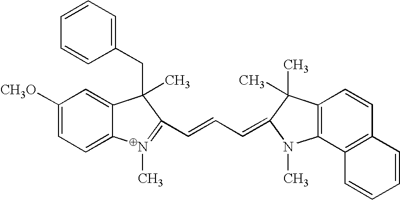 |
| T6 | 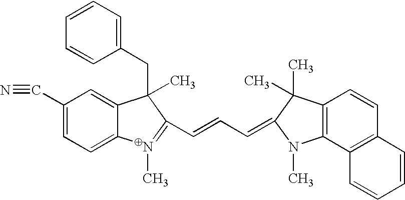 |
| T7 | 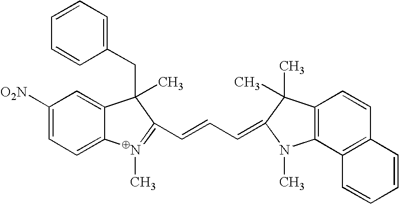 |
| T8 | 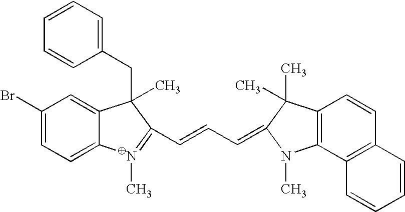 |
| T9 | 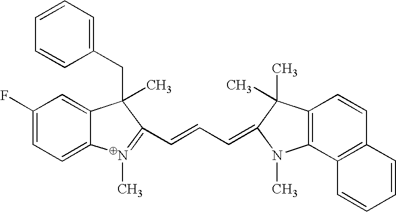 |
| T10 | 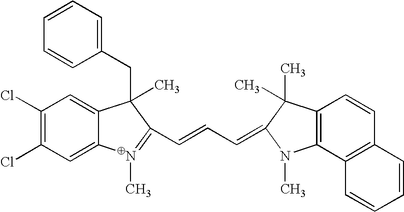 |
| T11 | 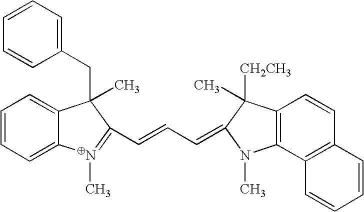 |
| T12 | 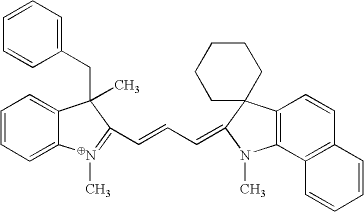 |

TABLE 8

| No. | |
|---|---|
| T13 | 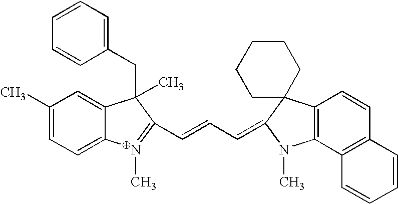 |
| T14 | 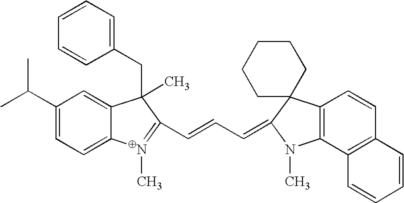 |
| T15 | 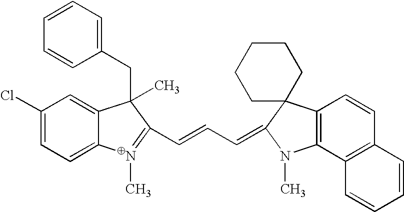 |
| T16 | 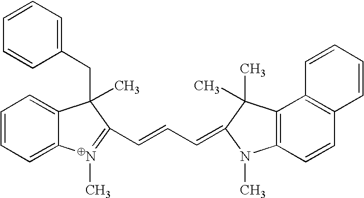 |
| T17 | 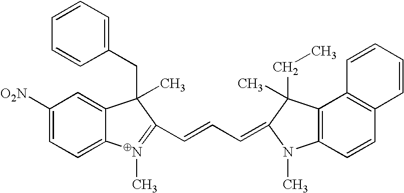 |
| T18 | 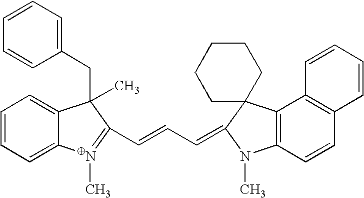 |
| T19 | 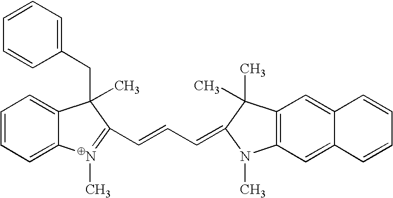 |
| T20 | 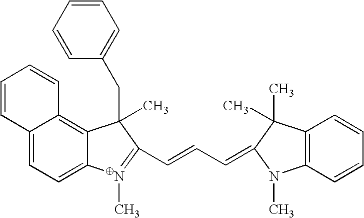 |
| T21 | 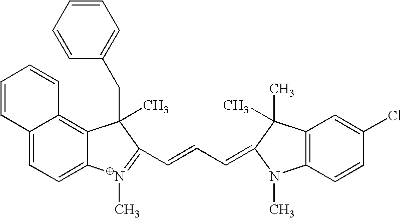 |
| T22 | 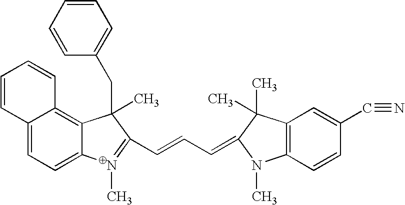 |
| T23 | 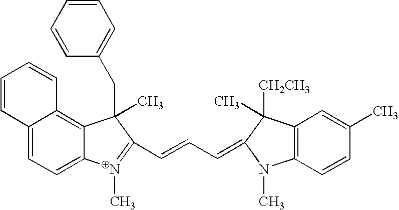 |
| T24 | 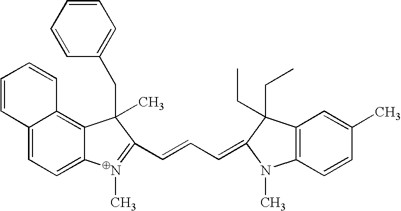 |

TABLE 9

| No. | |
|---|---|
| T25 | 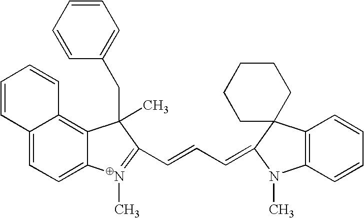 |
| T26 | 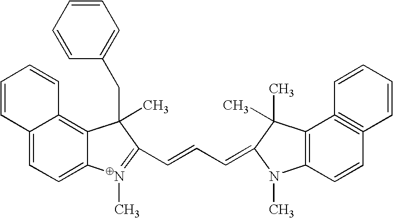 |
| T27 | 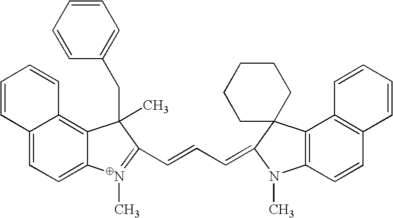 |
| T28 | 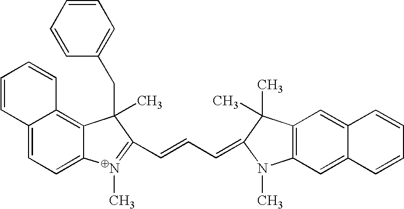 |
| T29 | 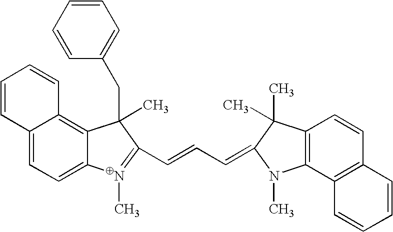 |
| T30 | 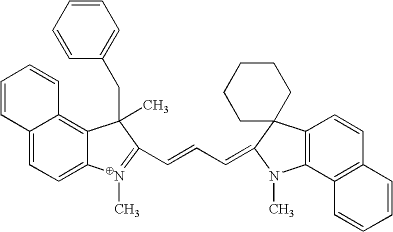 |
| T31 | 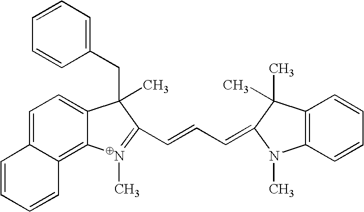 |
| T32 | 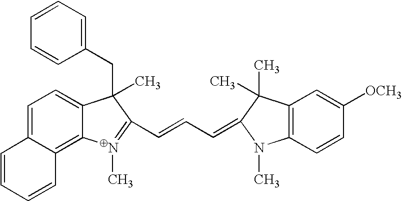 |
| T33 | 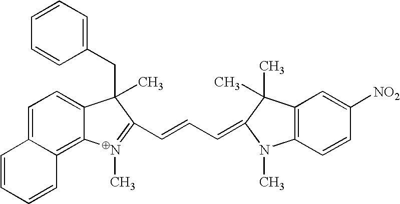 |
| T34 | 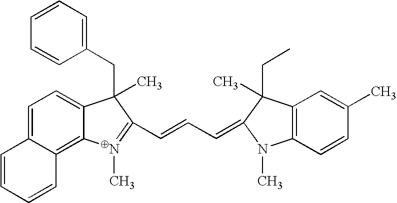 |
| T35 | 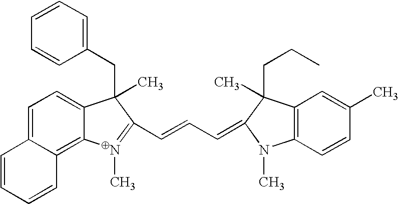 |
| T36 | 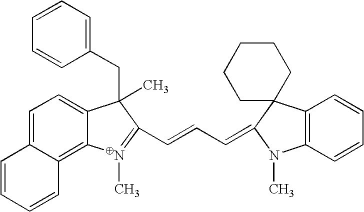 |

TABLE 10

| No. | |
|---|---|
| T37 | 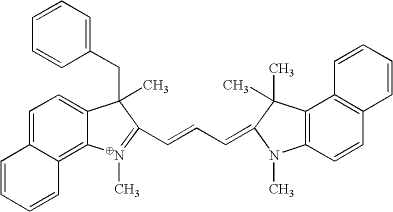 |
| T38 | 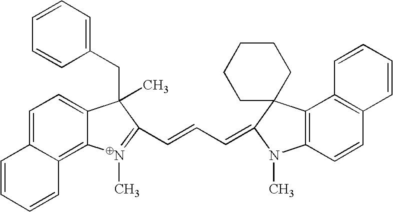 |
| T39 | 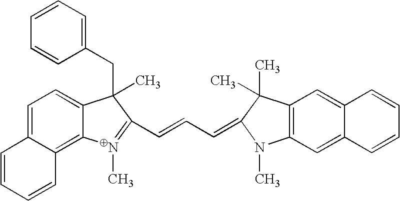 |
| T40 | 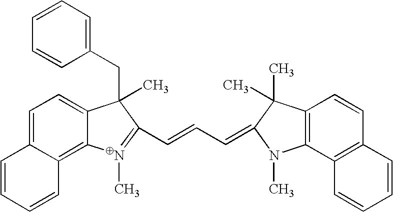 |
| T41 | 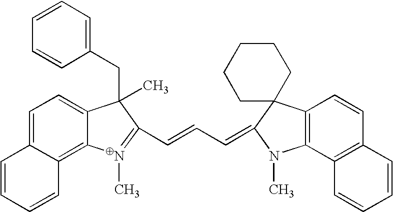 |
| T42 | 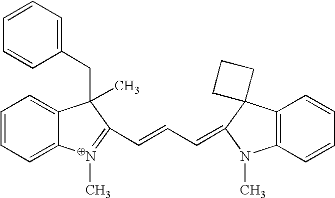 |
| T43 | 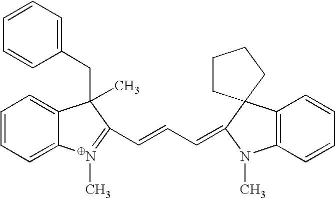 |
| T44 | 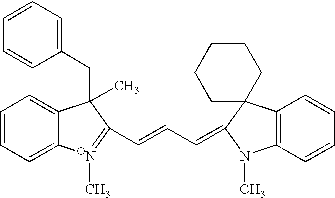 |
| T45 | 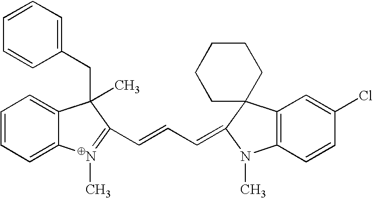 |
| T46 | 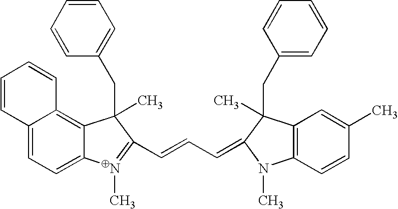 |
| T47 | 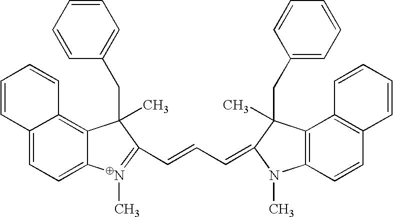 |
| T48 | 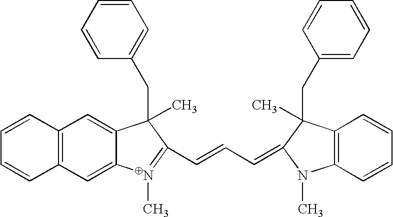 |

TABLE 11

| No. | |
|---|---|
| T49 | 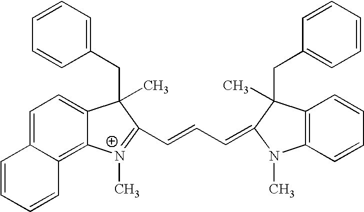 |
| T50 | 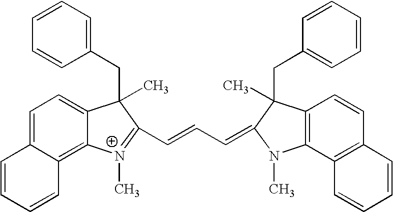 |
| T51 | 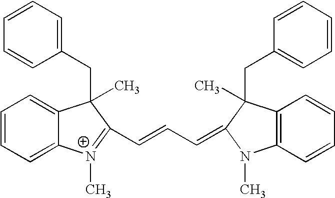 |
| T52 | 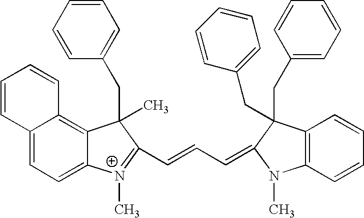 |
| T53 | 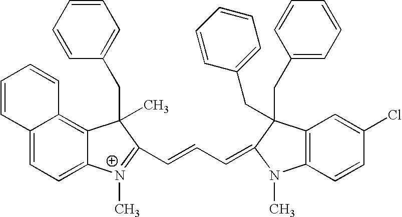 |
| T54 | 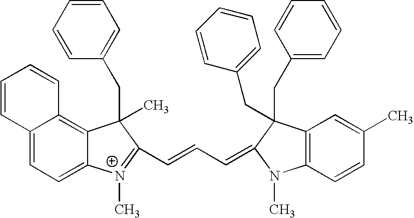 |
| T55 | 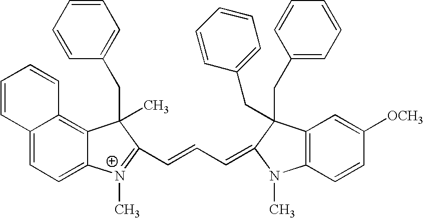 |
| T56 | 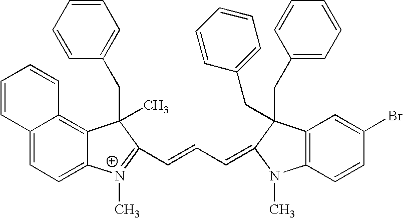 |
| T57 | 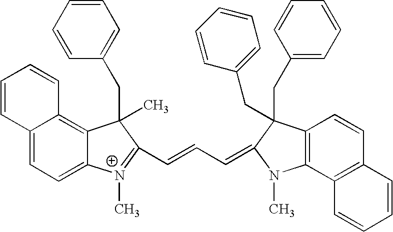 |
| T58 | 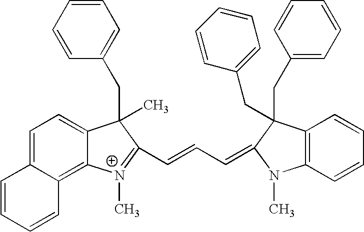 |
| T59 | 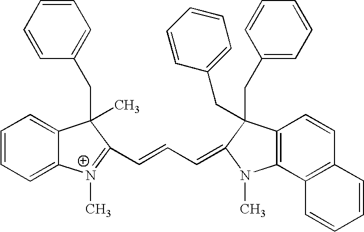 |
| T60 | 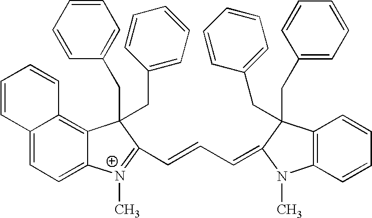 |

TABLE 12

| No. | |
|---|---|
| T61 | 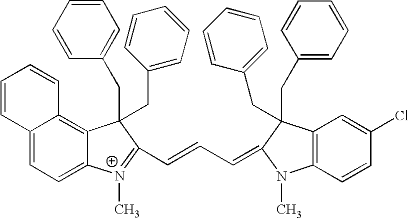 |
| T62 | 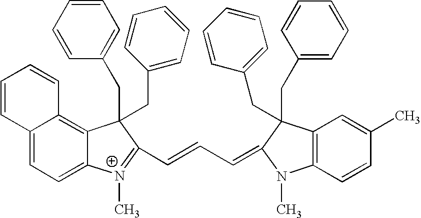 |
| T63 | 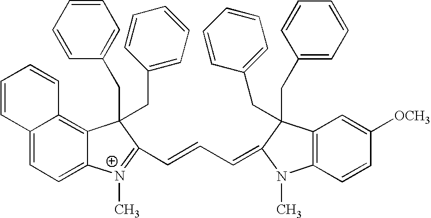 |
| T64 | 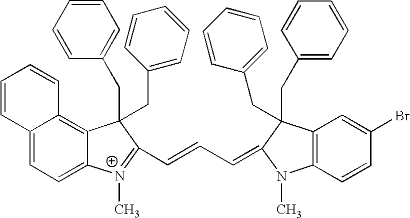 |
| T65 | 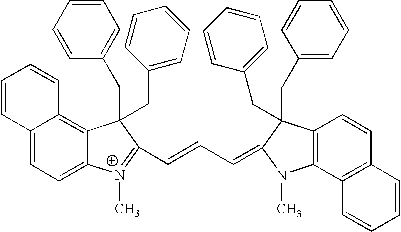 |
| T66 | 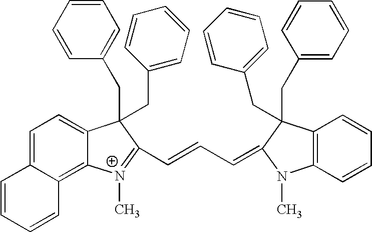 |
| T67 | 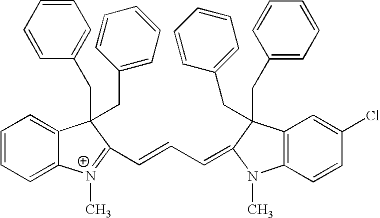 |

The method of evaluating the suitability of a dye component for optical recording media according to this embodiment (hereinafter referred to simply as “suitability evaluating method”) will now be explained.

There are no particular restrictions on the apparatus used for spectrophotometric analysis for measurement (calculation) of the absorbance of the sample containing the dye component in the suitability evaluating method of this embodiment, and any conventional publicly known apparatus may be used which allows measurement of the intensity of light incident to the sample and the intensity of light transmitted and/or reflected from the sample.

First, a sample containing the dye component is prepared. The sample is fabricated, for example, by combining the dye component to be measured, a resin and a solvent. The dye component used is not particularly restricted and may be one such as mentioned for the optical recording material described above. The resin is also not particularly restricted so long as it is transparent, soluble in the solvent, suitable for coating and does not melt, lose transparency or react with the dye component or other resins when heated in the first step described hereunder. As such resins there may be mentioned polycarbonate (PC) and polymethacrylate (PMMA). The solvent is not particularly restricted so long as it volatilizes at low temperature, does not easily react with the resin or dye component and has good transparency, and as examples there may be mentioned dichloromethane, chloroform, monochlorobenzene, DMF and the like. The sample volume is not particularly restricted so long as it is within the range permitted by the apparatus and allows absorbance measurement.

After molding the sample as necessary, it is set in the measuring (analyzing) apparatus. For example, when the sample has been fabricated by combining the dye component, a resin and a solvent, it will be in a paste form. The sample is then coated onto a base made of glass or the like by a publicly known method such as spin coating, and then subjected to drying treatment to evaporate off the solvent, and the resulting sample set in the measuring apparatus.

Next, the temperature of the sample or the temperature of the atmosphere surrounding the sample is set to two or more different prescribed temperatures, and the absorbance of the sample for light of a prescribed wavelength is measured at each prescribed temperature (first step). The method of measuring the absorbance is not particularly restricted so long as it is a publicly known method, and for example, the absorbance may be measured (calculated) by irradiating light of a prescribed wavelength onto the sample and measuring the intensity of light incident to the sample, the intensity of light transmitted from the sample and, when necessary, the intensity of reflected light. The light irradiated onto the sample is not particularly restricted so long as it includes the prescribed wavelength for measurement of the absorbance, and depending on the need there may be used white light, visible light or ultraviolet light.

There are no particular restrictions on the prescribed wavelength of the light for measurement of the absorbance, but from the standpoint of promoting a high correlation between the prescribed temperature and the suitability for optical recording media, it is preferably lower than the wavelength of laser light which is irradiated onto the optical recording medium, during recording of information onto the optical recording medium which includes in its recording layer the dye component to be measured, while it is also preferably a wavelength at which the maximum value (maximum peak) of absorbance is exhibited at a given prescribed temperature, or a nearby wavelength. In addition, among the maximum peaks of absorbance at the short wavelength end from the wavelength of the laser light, it is more preferably the wavelength of the maximum peak nearest to the wavelength of the laser light. For example, if the optical recording medium is a DVD±R (recording/reading wavelength=650 nm), the prescribed wavelength is preferably 500-650 nm.

The absorbance measurement is accomplished by varying the temperature of the sample or the atmosphere surrounding the sample to two or more different prescribed temperatures, and carrying out the measurement at those prescribed temperatures. The method of varying the temperature is not particularly restricted, but a method of temperature elevation is preferred since heating dye components usually produces thermal deformation which is irreversible. The temperature elevating program is not particularly restricted, and the absorbance may even be measured while elevating the temperature at a fixed rate. Alternatively, the absorbance may be measured by repeating a process in which the temperature is elevated in stages, i.e. the temperature is increased to a prescribed temperature and sustained for measurement of the absorbance, after which the temperature is then elevated to the next prescribed temperature.

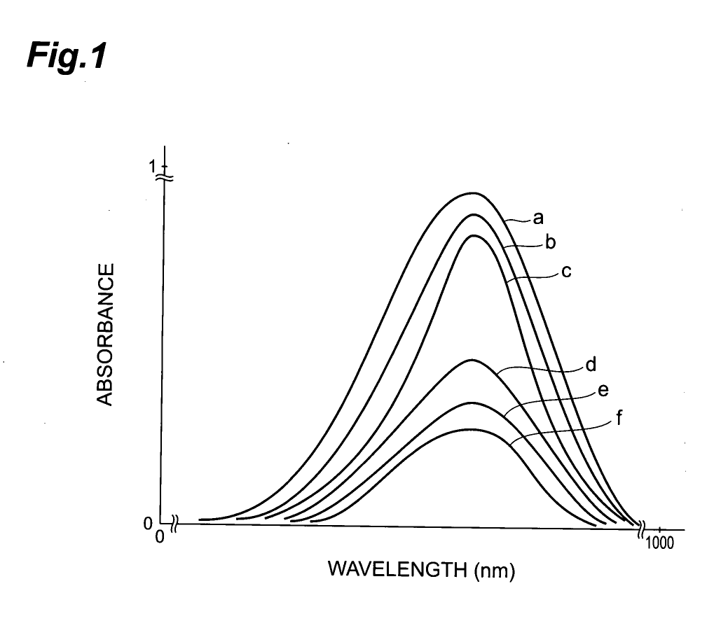

Measurement of the absorbance in this manner will yield a plurality of absorption spectra such as shown in FIG. 1, for example. The curves (spectra) indicated by reference letters a, b, c, d, e and f in FIG. 1 represent the absorption spectra for different prescribed temperatures. For example, in the case of thermal decomposition of the dye component where the thermal decomposition results in newly produced components which readily volatilize at the heating temperature, or when the components newly produced from thermal decomposition have low absorption in the visible light range, the absorption spectra in FIG. 1 tend to change in the order a, b, c, d, e, f with a higher prescribed temperature.

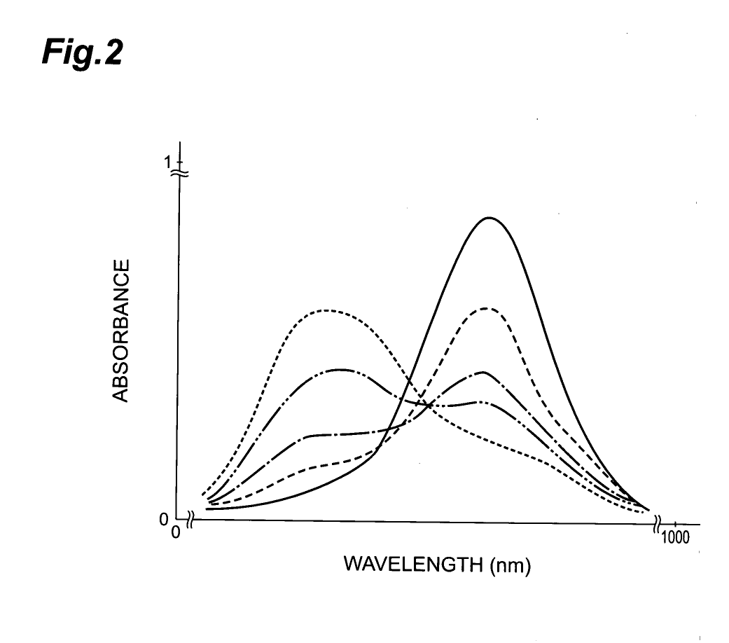

On the other hand, when heating of the dye component causes decomposition of the dye component or its conversion to other components, and the newly produced components do not readily volatilize at the heating temperature, a plurality of absorption spectra may be obtained at each different prescribed temperature, as shown in FIG. 2.

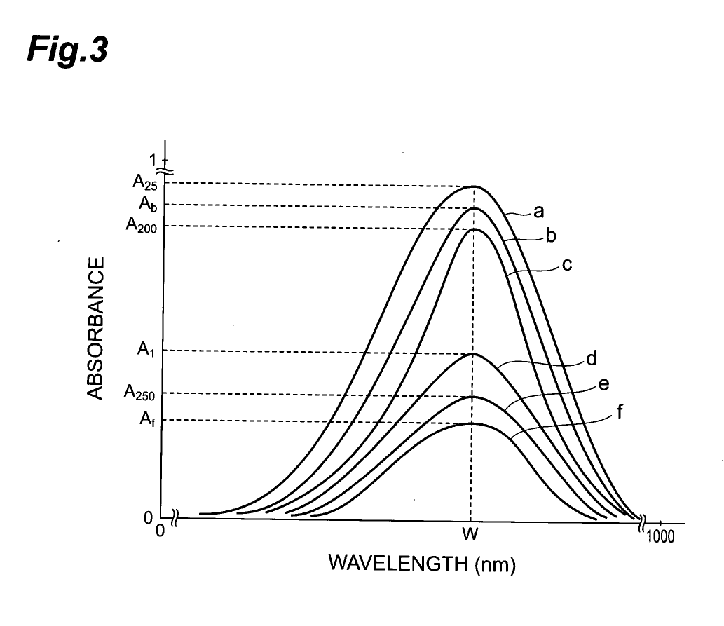

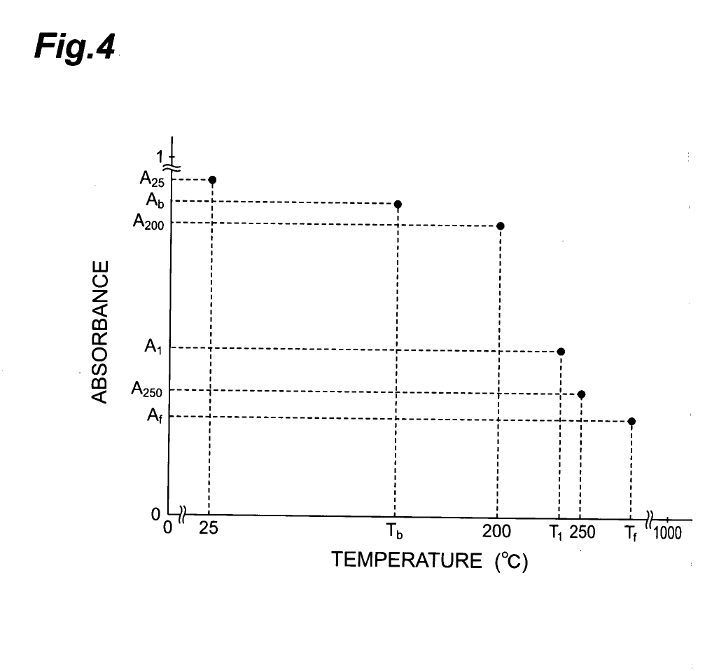

Next, the suitability of the dye component for use in the recording layer of an optical recording medium is evaluated based on one or more conditions determined from the correlation between the prescribed temperature and absorbance (second step). This will now be explained in detail with reference to FIGS. 3 and 4, using an example wherein the absorption spectra shown in FIG. 1 change in the order a, b, c, d, e, f as the prescribed temperature (referred to in the following paragraphs as “heating temperature”) increases.

FIG. 3 shows the absorption spectra a, b, c, d, e and f at the different heating temperatures of 25° C., T_{b}° C., 200° C., T₁° C., 250° C. and T_{f}° C., where absorbance was measured using a sample containing a certain dye component; the horizontal axis represents the wavelength of absorbed light (units: nm) and the vertical axis represents the absorbance. The correlation between absorbance and heating temperature is shown in the graph of FIG. 4, where A₂₅, A_{b}, A₂₀₀, A₁, A₂₅₀ and A_{f} are the absorbance values for each spectrum at wavelength W (nm). In the graph of FIG. 4, the horizontal axis represents the heating temperature (units: ° C.) and the vertical axis represents absorbance.

The correlation between prescribed temperature and absorbance is examined for different dye components in this manner, and the dye components are included in recording layers of optical recording media to confirm the recording and reading characteristics. The correlation between prescribed temperature and absorbance for a dye component which will give satisfactory recording and reading characteristics will thus become apparent, and the determined correlation will allow conditions to be set for evaluating the suitability of dye components for inclusion into the recording layers of optical recording media.

For example, the present inventors examined the correlation between prescribed temperature and absorbance in the manner described above for numerous dye components, and confirmed the recording characteristics of the dye components. As a result, it was discovered that when a dye component satisfying the conditions described below is added to the recording layer, it is possible to obtain an optical recording medium exhibiting notably superior recording characteristics particularly with high-speed recording of at least 4×, i.e. a linear speed of 14 m/sec or greater.

Specifically, it was discovered that if, as shown in FIG. 4, T₁ satisfies the condition represented by inequality (1) below, and A_{L} and A_{H} satisfy the condition represented by inequality (14) below, where A_{L} is the absorbance at the lower limit temperature and A_{H} is the absorbance at the higher limit temperature of an arbitrarily selected temperature range including T₁ in FIG. 4, the increase in jitter and increase in error rate caused by recording of information onto the recording layer are satisfactorily inhibited.
200≦T₁≦250 (1)
In formula (1), T₁ represents a prescribed temperature which produces absorbance satisfying the relationship represented by the following equality (3):
A₁=A₂₅/2 (3).
0.50≦{(A_{L}−A_{H})/A_{L}}≦1.00 (14)

It was further discovered that if the lower limit temperature is 200° C. and the upper limit temperature is 250° C., i.e. if the dye component satisfies the condition represented by inequality (2) below, it is possible to more reliably obtain an optical recording medium with adequately superior recording characteristics.
0.50≦{(A₂₀₀−A₂₅₀)/A₂₀₀}≦1.00 (2)

If T₁ is below 200° C., the stability of the dye component will tend to be lower and reading defects will tend to occur more easily. If T₁ is above 250° C., the recording sensitivity will be reduced and it will tend to be difficult to accomplish the desired precision of recording even if the laser power used for recording is increased to the limit of the apparatus. If (A₂₀₀−A₂₅₀)/A₂₀₀ is less than 0.50, optical changes (thermal deformation) of the recording layer will occur across a wide range, resulting in lower bit resolution and potential increase in the error rate.

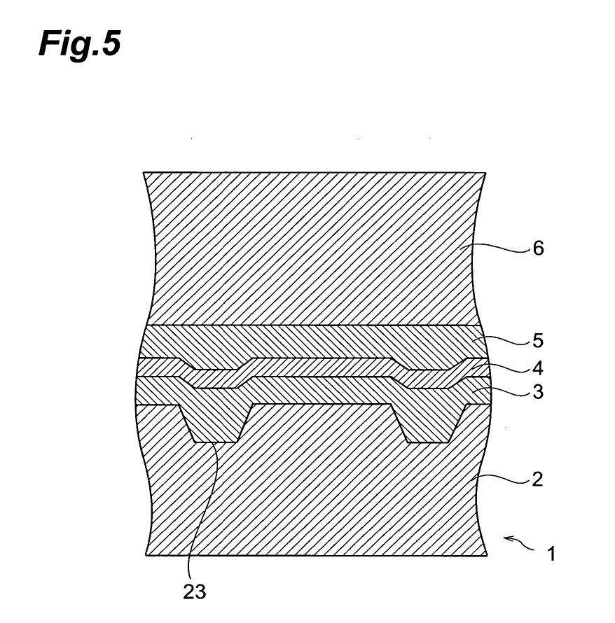

An optical recording medium according to this embodiment will now be explained. FIG. 5 is a partial cross-sectional view showing a preferred embodiment of an optical recording disk with an optical recording medium of the invention. The optical recording disk 1 shown in FIG. 5 has a laminated structure formed by bonding a recording layer 3, reflective layer 4, protective layer 5 and base 6 in that order on a base 2. The optical recording disk 1 is a write-once optical recording disk, capable of recording and reading with light having a short wavelength of 630-685 nm.

The base 2 and base 6 are disk-shaped with a diameter of about 64-200 mm and a thickness of about 0.6 mm each. Recording and reading are accomplished from the back side of the base 2 (opposite side to the base 6). Thus, at least the base 2 must have essential transparency for the recording light and reading light. More specifically, the base 2 preferably has a transmittance of at least 88% for the recording light and reading light. The material of the base 2 is preferably a resin or glass satisfying the aforementioned conditions for transmittance, and particularly preferred are thermoplastic resins such as polycarbonate resins, acrylic resins, amorphous polyethylene, TPX, polystyrene and the like. On the other hand, the material of the base 6 is not particularly restricted and may be, for example, the same material as the base 2.

The side of the base 2 on which the recording layer 3 is to be formed has a tracking groove 23 formed as a depression. The groove 23 is preferably a continuous spiral groove, preferably with a depth of 0.1-0.25 μm, a width of 0.20-0.50 μm and a groove pitch of 0.6-1.0 μm. Constructing the groove in this manner will allow a satisfactory tracking signal to be obtained without reducing the reflection level of the groove. The groove 23 may be formed simultaneously with molding of the base 2 by extrusion molding using the aforementioned resin, but alternatively a resin layer having a groove 23 may be formed by the 2P method after manufacture of the base 2, and a composite base subsequently formed from the base 2 and the resin layer.

The recording layer 3 is formed with inclusion of a dye component which simultaneously satisfies the conditions represented by inequalities (1) and (2) above. The recording layer 3 may be formed by coating the base 2 with a mixed solution obtained by dissolving or dispersing the optical recording material of this embodiment in a solvent and removing the solvent from the coated film. As solvents for the mixed solution there may be mentioned alcohol-based solvents (including alkoxyalcohol-based solvents such as ketoalcohols and ethyleneglycol monoalkyl ethers), aliphatic hydrocarbon-based solvents, ketone-based solvents, ester-based solvents, ether-based solvents, aromatic-based solvents and halogenated alkyl-based solvents, among which alcohol-based solvents and aliphatic hydrocarbon-based solvents are preferred.

The alcohol-based solvent is preferably alkoxyalcohol-based or ketoalcohol-based. An alkoxyalcohol-based solvent preferably has an alkoxy portion of 1-4 carbon atoms and an alcohol portion of 1-5 carbon atoms, or more preferably 2-5 atoms, with a total of 3-7 carbon atoms. More specifically there may be mentioned ethyleneglycol monoalkyl ethers (cellosolves) such as ethyleneglycol monomethyl ether (methyl cellosolve), ethyleneglycol monoethyl ether (also known as ethyl cellosolve and ethoxyethanol), butylcellosolve and 2-isopropoxy-1-ethanol, or 1-methoxy-2-propanol, 1-methoxy-2-butanol, 3-methoxy-1-butanol, 4-methoxy-1-butanol and 1-ethoxy-2-propanol. As a keto alcohol there may be mentioned diacetone alcohol. Fluorinated alcohols such as 2,2,3,3-tetrafluoropropanol may also be used.

As aliphatic hydrocarbon-based solvents there are preferred n-hexane, cyclohexane, methylcyclohexane, ethylcyclohexane, cyclooctane, dimethylcyclohexane, n-octane, iso-propylcyclohexane and t-butylcyclohexane, among which ethylcyclohexane, dimethylcyclohexane and the like are especially preferred.

As a ketone-based solvent there may be mentioned cyclohexanone.

According to this embodiment, alkoxyalcohols such as ethyleneglycol monoalkyl ethers are preferred, and particularly ethyleneglycol monoethyl ether, 1-methoxy-2-propanol and 1-methoxy-2-butanol. The solvent used may be a single type, or it may be a mixed solvent of two or more types. For example, a mixed solvent of ethyleneglycol monoethyl ether and 1-methoxy-2-butanol is suitable for use.

The mixture may also contain binders, dispersing agents, stabilizers and the like as appropriate, in addition to the components mentioned above.

As methods for coating the mixture there may be mentioned spin coating, gravure coating, spray coating and dip coating, among which spin coating is preferred.

The thickness of the recording layer 3 formed in this manner is preferably 50-300 nm. Outside of this range the reflectance will be lowered, making it difficult to achieve a level of reading conforming to DVD standards. If the thickness of the recording layer 3 is at least 100 nm, and especially 130-300 nm, at the position above the groove 23, a very large modulation factor will be realized.

The extinction coefficient (imaginary part of the complex refractive index k) of the recording layer 3 for the recording light and reading light is preferably 0-0.20. If the extinction coefficient is greater than 0.20, sufficient reflectance may not be achieved. The refractive index (real part of the complex refractive index n) of the recording layer 3 is preferably at least 1.8. If the refractive index is less than 1.8, the modulation factor of the signal will tend to be smaller. The upper limit for the refractive index is not particularly restricted, but it will normally be about 2.6 for convenience of the organic dye synthesis.

The extinction coefficient and refractive index of the recording layer 3 may be determined according to the following procedure. First, a measurement sample is fabricated by forming a recording layer of about 40-100 nm on a prescribed transparent base, and then the reflectance through the measurement sample base or the reflectance from the recording layer side is measured. In this case, the reflectance is measured based on mirror reflection (about 5°) using the wavelength of the recording and reading light. The light transmittance of the sample is also measured. The measured values are used to calculate the extinction coefficient and refractive index according to the method described in, for example, “Kogaku [Optics]”, K. Ishiguro, pp. 168-178, Kyoritsu Zensho Publishing.

A reflective layer 4 is provided on the recording layer 3 by bonding onto the recording layer 3. The reflective layer 4 may be formed by vapor deposition, sputtering or the like using a metal or alloy with high reflectance. As metals and alloys there may be mentioned gold (Au), copper (Cu), aluminum (Al), silver (Ag), AgCu and the like. The thickness of the reflective layer 4 formed in this manner is preferably 10-300 nm.

On the reflective layer 4 there is formed a protective layer 5 by bonding onto the reflective layer 4. The protective layer 5 may be in layer or sheet form, and for example, it may be formed by coating the reflective layer 4 with a coating solution containing a material such as an ultraviolet curing resin and drying the coated solution if necessary. The coating may be accomplished by appropriate spin coating, gravure coating, spray coating, dip coating or the like. The thickness of the protective layer 5 formed in this manner is preferably 0.5-100 μm.

On the protective layer 5 there is formed a base 6 by bonding to the protective layer 5. The base 6 may have the same material composition and thickness as the base 2, and it may optionally have a groove formed therein. In order to further increase adhesion between the base 6 and the protective layer 5, an adhesive layer as described below may be provided on the protective layer 5, with the base 6 formed thereover.

During writing or reading of the optical recording disk 1 having this construction, recording light of a prescribed wavelength is irradiated in pulse form from the back side of the base 2 to vary the photoreflectance of the irradiated section. At this time, the optical recording disk 1 on which the recording layer 3 comprising the dye component of the invention is formed allows jitter to be adequately prevented at high density recording pattern sections having relatively narrow pitch distances, thus sufficiently preventing error rate increase, even in the case of high-speed recording of at least 4× speed, i.e. a linear speed of 14 m/sec.

The aforementioned embodiment was explained for an optical recording disk provided with a single recording layer 3 as the recording layer, but a plurality of recording layers may also be provided, with different dyes in each layer. This will allow recording and reading of information to be accomplished by a plurality of different recording and reading light beams with either the same or different wavelengths.

The optical recording disk 1 obtained in this manner may also be used by attaching together two optical recording disks 1, or a single optical recording disk 1 and another optical recording disk having a different construction from the optical recording disk 1, with their light-incident sides (base 2 sides) facing outward.

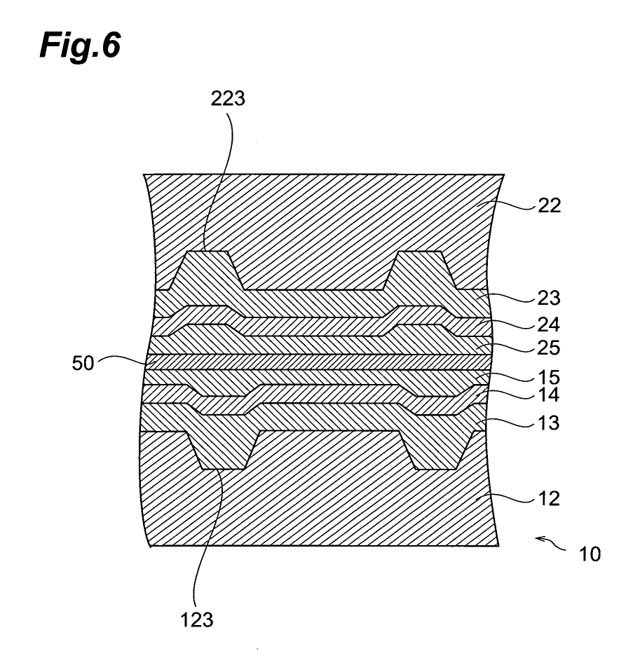

FIG. 6 is a partial cross-sectional view showing a preferred embodiment of an optical recording disc according to the attachment mode described above. The optical recording disk 10 shown in FIG. 6 has a laminated structure comprising a base 12, a recording layer 13, a reflective layer 14, a protective layer 15, an adhesive layer 50, a protective layer 25, a reflective layer 24, a recording layer 23 and a base 22 formed in that order. That is, the optical recording disk 10 has a construction wherein two optical recording disks having the same construction as the optical recording disk 1 shown in FIG. 5 are attached together with their respective protective layers facing and sandwiching the adhesive layer 50. The optical recording disk 10 is a write-once digital video disk conforming to the DVD standard, whereby recording and reading are accomplished by light with a short wavelength of 650 nm.

The adhesive layer 50 used may be a hot-melt adhesive, ultraviolet curing adhesive, thermosetting adhesive, tacky adhesive or the like, and it may be formed by an appropriate method such as, for example, roll coating, screen printing, spin coating or the like. For a DVD±R, screen printing or spin coating using an ultraviolet curing adhesive is preferred from the standpoint of overall balance between workability, productivity and disk characteristics. The thickness of the adhesive layer 50 is preferably about 10-200 μm.

The bases 12 and 22, the recording layers 13 and 23, the reflective layers 14 and 24 and the protective layers 15 and 25 are formed of the same materials and by the same method as for the optical recording disk 1 shown in FIG. 5. The thicknesses of the bases 12 and 22 are preferably about 0.6 mm. Grooves 123 and 223 are formed on the side of the base 12 on which the recording layer 13 is formed and on the side of the base 22 on which the recording layer 23 is formed, respectively. The grooves 123 and 223 preferably have depths of 60-200 nm, widths of 0.2-0.5 μm and groove pitches of 0.6-1.0 μm. The thicknesses of the recording layers 13 and 23 are preferably 50-300 nm, and the complex refractive index for light of 650 nm is preferably n=1.8-2.6, k=0.02-0.20.

### EXAMPLES

The present invention will now be explained in greater detail through examples, with the understanding that the examples are in no way limitative on the invention.

### Dye Component Absorbance Measurement

The following dye materials S1-S9 were synthesized by ordinary methods. Samples were prepared by combining 10 mg of the obtained dye materials, or of dye components prepared by combining two of the dye materials, 90 mg of polycarbonate and 3.5 g of dichloromethane. Each of the obtained samples was coated by spin coating (2000 rpm) onto a glass panel (25 mm×25 mm×0.1 mm) and vapor deposited with Al to a thickness of 100 nm, to obtain a laminated body. The laminated body was then dried at 80° C. for 1 hour. The dye components used were dye component Nos. 1-8 shown in Table 13. The values in parentheses in Table 13 represent the molar mixing ratios of the dye materials.

| No. | |
|---|---|
| S1 | 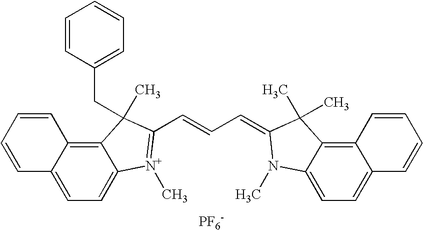 |
| S2 | 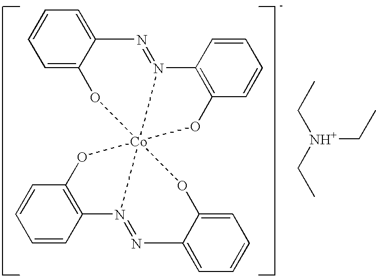 |
| S3 | 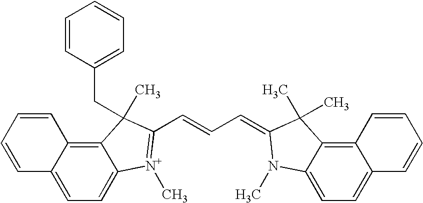 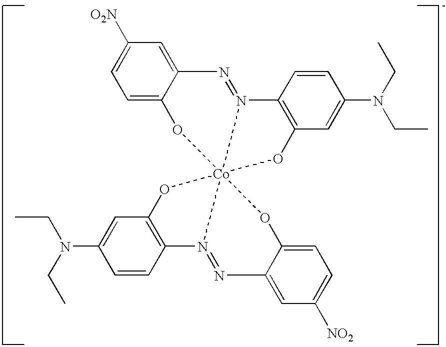 |
| S4 | 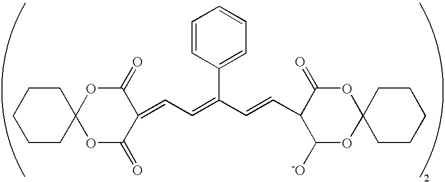 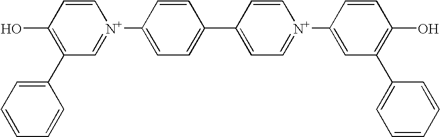 |
| S5 | 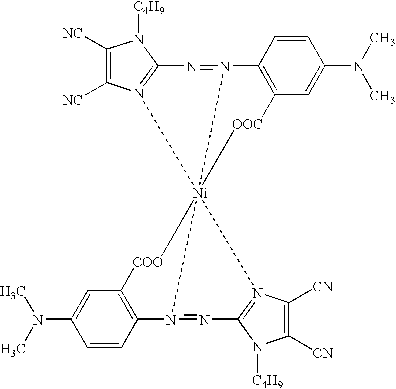 |
| S6 | 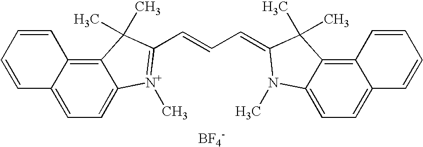 |
| S7 | 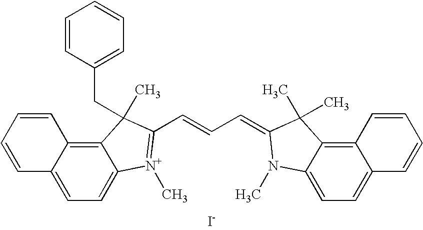 |
| S8 | 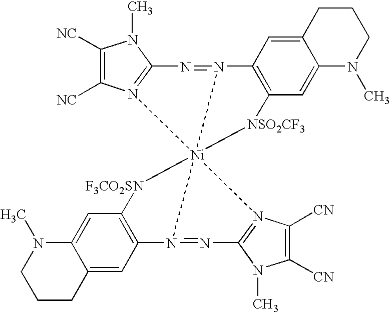 |
| S9 | 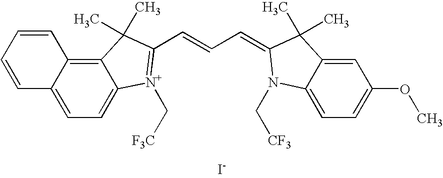 |

TABLE 13

| | | Recording | |
|---|---|---|---|
| Sample No. | Dye component No. | power (mW) | PI error |
| Example 1 | 1 | 26 | 15 |
| Example 2 | 2 | 29 | 21 |
| Example 3 | 3 | 27 | 18 |
| Example 4 | 4 | 33 | 81 |
| Example 5 | 5 | 28 | 24 |
| Comp. Ex. 1 | 6 | 26 | 560 |
| Comp. Ex. 2 | 7 | unrecordable | — |
| Comp. Ex. 3 | 8 | 32 | 292 |

Using a reflection measuring system (MCPD-3000, product of Otsuka Denshi) as the spectrophotometric analyzer, the dried laminated body was placed on the heater and prescribed temperatures were set every 5-10° C. while heating in air at a temperature elevating rate of 10° C./min, and the absorbance (absorption spectrum) of the sample was measured at each wavelength for each prescribed temperature (first step).

Based on the obtained absorption spectrum, the maximum peak nearest to 650 nm among the maximum peaks of absorbance at the short wavelength end from 650 nm was plotted for each of the aforementioned prescribed temperatures, producing a graph as shown in FIG. 4. The prescribed temperature T₁ which resulted in a wavelength for A₁=A₂₅/2 represented by inequality (3) above was determined based on this graph. At the same time, (A₂₀₀−A₂₅₀)/A₂₀₀ of inequality (2) was also determined (second step). The results are shown in Table 14.

TABLE 14

| Dye component No. | T₁ (° C.) | (A₂₀₀ − A₂₅₀)/A₂₀₀ |
|---|---|---|
| 1 | 225 | 1.00 |
| 2 | 229 | 0.82 |
| 3 | 207 | 0.89 |
| 4 | 245 | 0.62 |
| 5 | 243 | 0.97 |
| 6 | 177 | 1.00 |
| 7 | 316 | 0.05 |
| 8 | 248 | 0.32 |

Based on the results of the second step, dye component Nos. 1-5 were used as the dye components for Examples 1-5, and dye component Nos. 6-8 were used as the dye components for Comparative Examples 1-3.

### Example 1

First, a polycarbonate resin base with a 120 mm diameter and a 0.6 mm thickness was prepared, having a pre-groove (0.12 μm depth, 0.30 μm width, 0.74 μm groove pitch) formed on one side. Separately, a dye component composed of the same material as dye component No. 1 was added to 2,2,3,3-tetrafluoropropanol to a content of 1.0 wt % to prepare a recording layer coating solution. The obtained coating solution was applied onto the side of the aforementioned polycarbonate resin base on which the pre-groove had been formed, and dried at 80° C. for 1 hour to form a recording layer (150 nm thickness). Next, an Ag reflective film (100 nm thickness) was formed on the recording layer by sputtering, and an ultraviolet curing resin SD-1700 (trade name of Dainippon Ink & Chemical Industries Co., Ltd.) was coated onto the Ag reflective layer by spin coating and then subjected to ultraviolet irradiation to form a transparent protective layer (8 μm thickness) composed of an acryl resin. Also, an ultraviolet curing resin SD-301 (trade name of Dainippon Ink & Chemical Industries Co., Ltd.) was coated onto the protective layer. Next, another identical transparent base with a thickness of 0.6 mm was laminated thereover and the excess ultraviolet curing resin was removed by high-speed spinning. Ultraviolet light was then irradiated through the laminated transparent bases for curing of the ultraviolet curing resin to form an adhesive layer, which was used to attach the protective layer and transparent bases in order to fabricate an optical recording medium (optical recording disk) for Example 1.

### Examples 2-5 and Comparative Examples 1-3

Optical recording disks for Examples 2-5 and Comparative Examples 1-3 were obtained in the same manner as Example 1, except that the dye components used were composed of the same materials as dye component Nos. 2-8 instead of the same material as dye component No. 1.

### Evaluation of Recording/Reading Characteristics

The optical recording media of Examples 1-5 and Comparative Examples 1-3 were irradiated with laser light of 650 nm wavelength using an optical disk evaluating apparatus (trade name: DDU-1000) by Pulstec Industrial Co., Ltd., for recording of a signal at a linear speed of 28 m/sec. The lens numerical aperture NA of the optical head mounted on the apparatus was 0.60. The recording was performed with a recording power which yielded an eye pattern with the eye center positioned at the center of a 14T waveform (see Table 15). After recording, the PI (Inner-code-parity) error (number of errors per 1 ECC block) value was determined.

A PI error of 280 or lower satisfies the DVD product standard. “Unrecordable” in the table means that no recording was possible even with the apparatus at maximum recording power.

TABLE 15

| | | Recording | |
|---|---|---|---|
| | Dye component No. | power (mW) | PI error |
| Example 1 | 1 | 26 | 15 |
| Example 2 | 2 | 29 | 21 |
| Example 3 | 3 | 27 | 18 |
| Example 4 | 4 | 33 | 81 |
| Example 5 | 5 | 28 | 24 |
| Comp. Ex. 1 | 6 | 26 | 560 |
| Comp. Ex. 2 | 7 | unrecordable | — |
| Comp. Ex. 3 | 8 | 32 | 292 |

The results of the recording/reading characteristic evaluation indicated that for dye components included in recording layers, if T₁ is in the range of 200-250° C. and (A₂₀₀−A₂₅₀)/A₂₀₀ in that temperature range is in the range of 0.50-1.00, the optical recording media provided with such recording layers exhibit satisfactory recording characteristics, such as low PI error even with high-speed recording.

What is claimed is:

1. A method of evaluating dye component suitability for optical recording media which comprises
a first step in which a temperature of a sample containing the dye component or a temperature of atmosphere surrounding said sample is set to two or more different prescribed temperatures, and an absorbance of said sample for light of a prescribed wavelength is measured at each of said prescribed temperatures, and
a second step in which suitability of including said dye component in a recording layer of the optical recording medium is evaluated based on one or more conditions which are set based on correlation between said prescribed temperatures and said absorbance.

2. A method of evaluating dye component suitability for optical recording media according to claim 1, wherein said prescribed wavelength is smaller than a wavelength of a laser light irradiated onto said optical recording medium during recording and/or reading of said optical recording medium.

3. A method of evaluating dye component suitability for optical recording media according to claim 1, wherein said prescribed wavelength is in the range of 500-650 nm.

4. A method of evaluating dye component suitability for optical recording media according to claim 1, wherein said conditions are represented by the following inequalities (1) and (2).
200≦T₁≦250 (1)
[wherein T₁ represents a prescribed temperature which produces the absorbance satisfying the relationship represented by the following equality (3):
A₁=A₂₅/2 (3)
(wherein A₁ represents the absorbance at T₁ and A₂₅ represents the absorbance at 25° C.)].
0.50≦{(A₂₀₀−A₂₅₀)/A₂₀₀}≦1.00 (2)
(wherein A₂₀₀ represents the absorbance at 200° C. and A₂₅₀ represents the absorbance at 250° C.).

5. An optical recording material used for an optical recording medium capable of recording information by irradiation of light,
wherein a dye component contained in said optical recording material simultaneously satisfies the conditions represented by the following inequalities (1) and (2) when a temperature of a sample containing said dye component or a temperature of an atmosphere surrounding said sample is set to two or more different prescribed temperatures, and an absorbance of said sample for light of a prescribed wavelength is measured at each of said prescribed temperatures.
200≦T₁≦250 (1)
[wherein T₁ represents a prescribed temperature (units: ° C.) which produces the absorbance satisfying the relationship represented by the following equality (3):
A₁=A₂₅/2 (3)
(wherein A₁ represents the absorbance at T₁ and A₂₅ represents the absorbance at 25° C.)].
0.50≦{(A₂₀₀−A₂₅₀)/A₂₀₀}≦1.00 (2)
(wherein A₂₀₀ represents the absorbance at 200° C. and A₂₅₀ represents the absorbance at 250° C.).

6. An optical recording medium capable of recording information by irradiation of light,
wherein a dye component contained in a recording layer provided in said optical recording medium simultaneously satisfies the conditions represented by the following inequalities (1) and (2) when a temperature of a sample containing said dye component or a temperature of an atmosphere surrounding said sample is set to two or more different prescribed temperatures, and an absorbance of said sample for light of a prescribed wavelength is measured at each of said prescribed temperatures.
200≦T₁≦250 (1)
[wherein T₁ represents a prescribed temperature (units: ° C.) which produces the absorbance satisfying the relationship represented by the following equality (3):
A₁=A₂₅/2 (3)
(wherein A₁ represents the absorbance at T₁ and A₂₅ represents the absorbance at 25° C.)].
0.50≦{(A₂₀₀−A₂₅₀)/A₂₀₀}≦1.00 (2)
(wherein A₂₀₀ represents the absorbance at 200° C. and A₂₅₀ represents the absorbance at 250° C.).
